(19) United States
(12) Patent Application Publication
(10) Pub. No.: US 2015/0003184 A1
(43) Pub. Date: Jan. 1, 2015

(54) Stirring Spatula with Wrench

(71) Applicant: Jeffrey Kenneth Jackson, Salt Lake City, UT (US)

(72) Inventor: Jeffrey Kenneth Jackson, Salt Lake City, UT (US)

(21) Appl. No.: 13/929,745

(22) Filed: Jun. 27, 2013

(51) Int. Cl. A47J 43/28

(52) U.S. Cl. CPC A47J 43/288
USPC 366/129

(57) ABSTRACT

This invention is spatula or spoon designed to conform to dimensions of a beverage cooler with a curved stirring vane on one end of the handle to facilitate dissolving a dehydrated additive to the liquid in the cooler, a penetration nub to aid in the perforation of a cooler liner, and a wrench on the other end of the handle to facilitate affixing a disposable liner within the cooler.

### CROSS-REFERENCE TO RELATED APPLICATIONS

This application relates to, and claims the benefit of the filing date of U.S. provisional patent application No. 61665028 filed on June 27, 2013.

### FIELD OF THE INVENTION

The present invention relates to, generally, a device for stirring liquid within a cooler, and more specifically, to stirring device dimensioned to fit within a beverage cooler which has a wrench to aid in affixing a liner to the cooler and a piercing device to facilitate piercing a hole in the liner that has been affixed to a cooler.

### BACKGROUND

Beverage coolers ranging in size from one to over twenty gallons are commonly used to provide refreshment for sports teams and other large group gatherings. Such coolers often are filled with liquids that include food dyes that can stain the integrated liner and or alter the taste of said coolers and or sugars that can create an environment that can breed unhealthy microorganisms.

### OBJECTS OF THE INVENTION

It is an object of the invention to overcome the forgoing disadvantages of the prior art.

It is a further object of the present invention to provide an apparatus and a system that makes it more convenient, cleaner and quicker to add dissolvable additives to a cooler through a disposable food grade plastic liner that can be affixed within a cooler, the instant device the facilitates affixing the liner, dissolving the additive within the liner and piercing the liner to allow the liquid to be dispersed without contaminating the integrated liner of the cooler.

One embodiment of the present invention can be utilized in the 10 gallon coolers commonly used to disperse water and sports drinking to athletic teams.

### Prior Art

3280764 Apparatus for rapid mixing, October, 1966

Potter et al. 3434804 Webbed Stirrer, March, 1969 Babington

4065107 Apparatus for mixing liquids, December, 1977 Van

Horbek 4312596 Beating blade member of beater, January, 1982 Maezawa et al.

Patent Application 20080247740 Device for Making a Beverage, October, 2008 Rijskamp et al. Patent Application 20090277341 Sweetening Stick for Stirring Beverage, November, 2009 Hjaltason 7934867 Stirring apparatus, May 2011, Yatomi et al

### SUMMARY OF THE INVENTION

The instant invention comprises a curved spatula or spoon designed to conform to the dimensions of a beverage cooler with a stirring vane on one end of the handle to facilitate dissolving a dehydrated additive to the liquid in the cooler, a wrench on the other end of the handle to facilitate affixing a liner within the cooler and a sharpened protrusion affixed to the side of the stirring vane that can pierce the installed disposable liner.

### BRIEF DESCRIPTION OF THE DRAWINGS

The foregoing and other objects, features and advantages will be apparent to those skilled in the art upon review of the detailed description herein, with reference to the drawings, in which:

FIG. 1 depicts a frontal view of an embodiment of the device

FIG. 2 depicts side view of an embodiment of the device;

FIG. 3 depicts side view of an alternate embodiment of the device with the wrench at 90 from the plane of the stirring vane.

FIG. 4 depicts the arc of the stirring vane.

### DETAILED DESCRIPTION

Typically, beverage coolers used to disperse liquid to individuals or groups have plastic integrated liners that can be stained by the food dyes within the stored beverages or become contaminated with sugars and other contaminants that can breed microorganisms and alter the taste of the beverage. Generally, the present invention is part of a system that provides a disposable plastic liner that can be affixed to a cooler using the cooler's integrated dispenser/faucet. The device described herein provides a convenient wrench to tighten a nut which affixes the plastic liner to the faucet. In the preferred embodiment, this wrench includes a 12 point closed wrench of a size to conform to the nut that is bent at an angle of 20 degrees to allow adequate space to place the wrench onto the nut and proves the maximum swing space for the wrench, by placing the opposite end of the wrench in the center of the cooler, such that, as the wrench is moved, it follows arc through the center of the cooler. It also provide an effective means of stirring the liquid in the liner to facilitate dissolving any additive, by providing a curved stirring vane with a curved radius that conforms to the sides of the cooler with has six holes placed in it to allow liquid to pass through it as it is stirred. Finally, the vane has a small sharp protrusion placed on its convex side designed to pierce the plastic liner without removing any plastic, thus ensuring that no plastic is allowed to be dispensed through the faucet of the cooler.

Any of the embodiments of the device can be formed or made out of plastic, metal, wood, or other material and may include both different shapes, forms, sizes or even advertising materials for brands and logos.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It is therefore contemplated that the claims will cover any such modifications or embodiments that fall within the true scope and spirit of the invention.

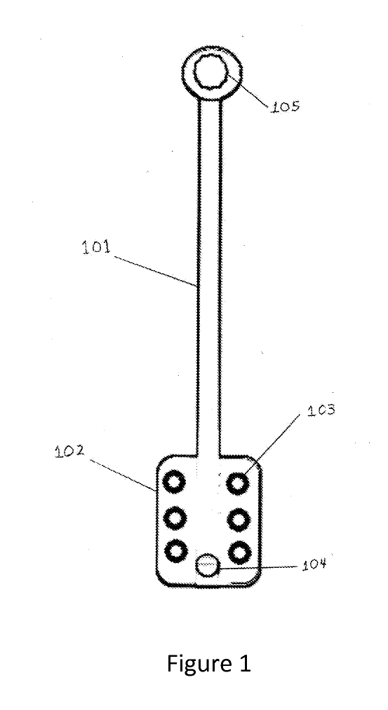

FIGS. 1-4, depict various embodiments of the present invention.

FIG. 1, 101 depicts an embodiment of the stirring device, with 102 the convex side of the stirring vane with 103 holes to facilitate dissolving additive in the liquid. 104 is the protrusion for piercing the plastic liner and 105 is the 12 point closed end wrench sized to fit the nut used to affix the liner to the cooler.

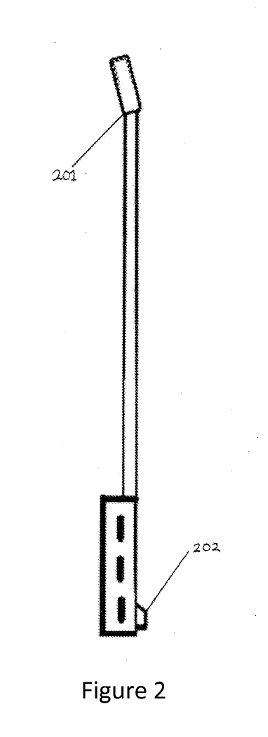

FIG. 2, illustrates the side view of an embodiment with 201 a 20 degree angle of the wrench (or other angle determined by the diameter of the cooler) to provide the maximum arc within the cooler for fastening the liner nut to the cooler faucet. 202 is the protrusion for piercing the liner.

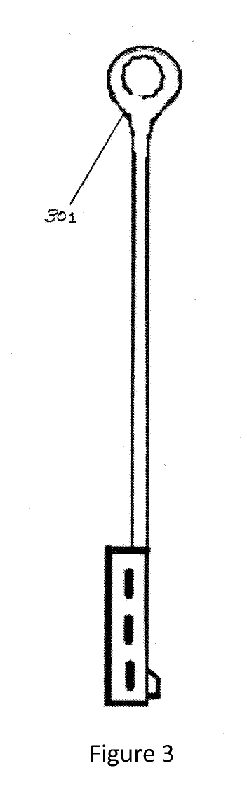

FIG. 3 is another embodiment of the device with the wrench set at 301 a 90 degree angle from the plane of the stirring vane, to allow for the handle to pass through a wider arc within the cooler before the stirring vane touches the side of the cooler.

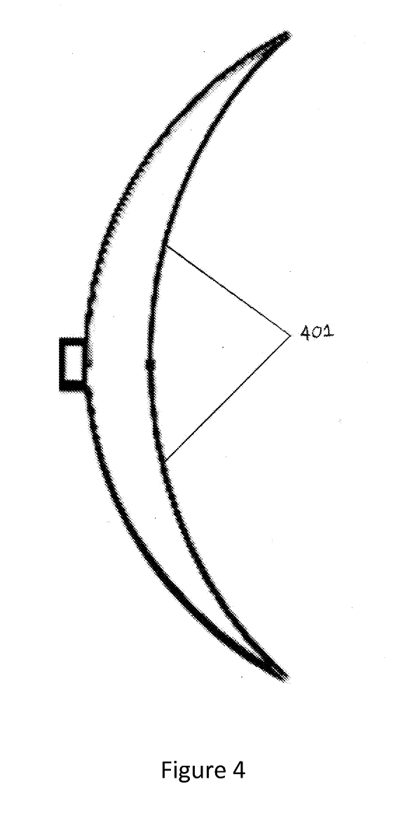

FIG. 4 is an end view of the stirring vane illustrating the way that the 401 radius of the vane is designed to conform to the internal radius of the cooler.

We claim:

1. An apparatus comprising: a spatula which conforms to dimensions of a beverage cooler with a curved stirring vane on the first end of a handle to facilitate dissolving a dehydrated additive to a liquid in said beverage cooler and a wrench on the second end of said handle to facilitate affixing an inner liner within said beverage cooler.

2. The apparatus of claim 1, wherein said spatula has holes that pass through said stirring vane to facilitate dissolving said dehydrated additive into said liquid within the liner inside the said beverage cooler.

3. The apparatus according to claim 2 or 3 further comprising a radius of said curved vane is designed to conform to an interior radius of said beverage cooler.

4. The apparatus of claim 3, further comprising a closed or open-ended wrench affixed to said handle of said spatula at the opposite end from said stirring vane at an angle designed to facilitate the widest possible arc for said wrench as it is used to affix said inner liner within said cooler.

5. The apparatus of claim 3 comprising a wrench with sufficient teeth to allow full engagement across an arch inscribed at the mouth of a cooler and of a dimension to match the liner nut used to affix the liner to the cooler.

6. The apparatus of claim 5, further comprising a protrusion affixed to the convex side of the stirring vane of a size and shape to facilitate piercing a hole, without removing any material, in a liner that has been affixed to a cooler.

7. The apparatus of claim 5, wherein said device may be formed or constructed of selected from the group consisting of metal, plastic, resin, wood, and any combination thereof.
